(19) United States
(12) Patent Application Publication
(10) Pub. No.: US 2016/0147184 A1
(43) Pub. Date: May 26, 2016

(54) FIXING DEVICE AND IMAGE FORMING APPARATUS

(71) Applicant: KYOCERA DOCUMENT SOLUTIONS INC., Osaka (JP)

(72) Inventors: Yoshihiro YAMAGISHI, Osaka-shi (JP); Yoshiharu KANEMATSU, Osaka-shi (JP)

(73) Assignee: KYOCERA Document Solutions Inc., Osaka (JP)

(21) Appl. No.: 14/900,079

(22) PCT Filed: Jan. 21, 2015
(86) PCT No.: PCT/JP2015/051536

§ 371 Date: Dec. 18, 2015

(30) Foreign Application Priority Data
Mar. 31, 2014 (JP) 2014-072988

(51) Int. Cl. G03G 15/20

(52) U.S. Cl. CPC G03G 15/2007

(57) ABSTRACT

A fixing device according to the present invention includes a fixing belt (22), a pressuring member (23) coming into pressure contact with the fixing belt (22) so as to form a fixing nip (52), a heat source (24) arranged at an inside of the fixing belt (22) and a reflecting member (25) reflecting the radiant heat radiated from the heat source (24). The reflecting member (25) includes a first reflecting part (61) inclining to a side of the fixing nip (52) toward an upstream side in a conveying direction of a recording medium and a second reflecting part (62) arranged at a more downstream side than the first reflecting part (61) in the conveying direction and at a further side from the fixing nip (52) than the first reflecting part (61) and covering a downstream side of the heat source (24) in the conveying direction.

### TECHNICAL FIELD

The present invention relates to a fixing device configured to fix a toner image onto a recording medium and an image forming apparatus including the fixing device.

### BACKGROUND ART

Conventionally, an electrographic image forming apparatus, such as a copying machine, a printer, a facsimile or a multifunction peripheral includes a fixing device configured to fix a toner image onto a recording medium, such as a sheet. For the fixing device, a heat roller manner is widely used. The heat roller manner is a manner to form a fixing nip by using a pair of rollers.

On the other hand, a fixing manner is being shifted from the above-mentioned heat roller manner to a belt manner to reduce a heat capacity of the fixing device and to shorten a warm-up time. The belt manner is a manner to form a fixing nip by using a fixing belt.

For example, Patent Document 1 discloses a fixing device including a fixing belt, a pressuring member (see “pressuring roller 22” of Patent Document 1) configured to come into pressure contact with the fixing belt so as to form a fixing nip, a heat source (see “halogen heater 23” of Patent Document 1) arranged at an inside in a radial direction of the fixing belt and a reflecting member configured to reflect a radiant heat radiated from the heat source.

[Patent Document 1] Japanese Unexamined Patent Application, Publication No. 2013-145288

### SUMMARY OF INVENTION

### Technical Problem

In Patent Document 1, as shown in FIG. 2 or the like, the reflecting member is opened to a separating side (a left side in FIG. 2 of Patent Document 1) from the fixing nip. Accordingly, it is impossible to intensively heat a part of the fixing belt (a lower part of the fixing belt in FIG. 2 of Patent Document 1) before the part goes into the fixing nip. Accompanying to this, the temperature of the fixing nip is lowered and there is a concern that it becomes difficult to securely fix a toner image onto a recording medium.

Taking the above-mentioned situation into consideration, an object of the present invention is to intensively heat a part of the fixing belt before the part goes into the fixing nip so as to securely fix a toner image onto a recording medium.

### Solution to Problem

A fixing device according to the present invention includes a fixing belt configured to be rotatable, a pressuring member configured to be rotatable and to come into pressure contact with the fixing belt so as to form a fixing nip, a heat source arranged at an inside in a radial direction of the fixing belt and configured to radiate a radiant heat and a reflecting member configured to reflect the radiant heat radiated from the heat source to an inner circumference face of the fixing belt. The reflecting member includes a first reflecting part configured to incline to a side of the fixing nip toward an upstream side in a conveying direction of a recording medium and a second reflecting part arranged at a more downstream side than the first reflecting part in the conveying direction of the recording medium and at a further side from the fixing nip than the first reflecting part and configured to cover a downstream side of the heat source in the conveying direction of the recording medium.

An image forming apparatus according to the present invention includes the above-mentioned fixing device.

### Advantageous Effects of Invention

The present invention makes it possible to intensively heat a part of the fixing belt before the part goes into the fixing nip so as to securely fix a toner image onto a recording medium.

### BRIEF DESCRIPTION OF DRAWINGS

FIG. 1 is a schematic diagram schematically showing a printer according to an embodiment of the present invention.

FIG. 2 is a sectional view showing a fixing device according to the embodiment of the present invention.

FIG. 3 is a perspective view showing the fixing device according to the embodiment of the present invention.

FIG. 4 is an exploded perspective view showing an upper frame part and a fixing belt in the fixing device according to the embodiment of the present invention.

FIG. 5 is a sectional view showing the fixing belt and its periphery in the fixing device according to the embodiment of the present invention.

FIG. 6 is a sectional view showing a fixing belt and its periphery in a fixing device according to another embodiment of the present invention.

FIG. 7 is a sectional view showing a fixing belt and its periphery in a fixing device according to another embodiment of the present invention.

FIG. 8 is a sectional view showing a fixing belt and its periphery in a fixing device according to another embodiment of the present invention.

### DESCRIPTION OF EMBODIMENTS

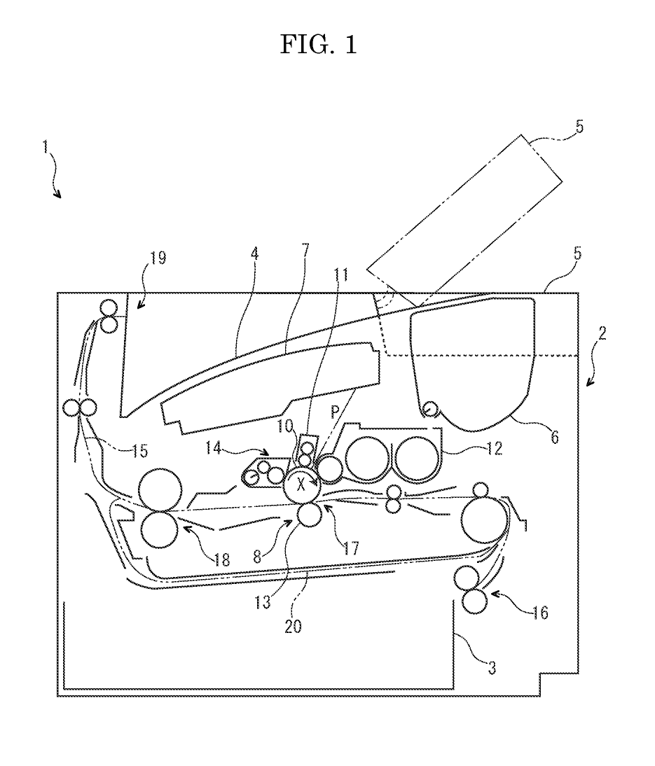

First, with reference to FIG. 1, the entire structure of a printer 1 (an image forming apparatus) will be described.

The printer 1 includes a box-like formed printer main body 2. In a lower part of the printer main body 2, a sheet feeding cartridge 3 storing sheets (recording mediums) is installed and, in a top face of the printer main body 2, an ejected sheet tray 4 is formed. To the top face of the printer main body 2, an upper cover 5 is openably/closably attached at a lateral side of the ejected sheet tray 4 and, below the upper cover 5, a toner container 6 is installed.

In an upper part of the printer main body 2, an exposure device 7 composed of a laser scanning unit (LSU) is located below the ejected sheet tray 4. Below the exposure device 7, an image forming part 8 is arranged. In the image forming part 8, a photosensitive drum 10 as an image carrier is rotatably arranged. Around the photosensitive drum 10, a charger 11, a development device 12, a transfer roller 13 and a cleaning device 14 are located along a rotating direction (refer to an arrow X in FIG. 1) of the photosensitive drum 10.

Inside the printer main body 2, a conveying path 15 for the sheet is arranged. At an upstream end in the conveying path 15, a sheet feeding part 16 is positioned. At an intermediate stream part in the conveying path 15, a transferring part 17 composed of the photosensitive drum 10 and transfer roller 13 is positioned. At a downstream part in the conveying path 15, a fixing device 18 is positioned. At a downstream end in the conveying path 15, a sheet ejecting part 19 is positioned. Below the conveying path 15, an inversion path 20 for duplex printing is arranged.

Next, the operation of forming an image by the printer 1 having such a configuration will be described.

When the power is supplied to the printer 1, various parameters are initialized and initial determination, such as temperature determination of the fixing device 18, is carried out. Subsequently, in the printer 1, when image data is inputted and a printing start is directed from a computer or the like connected with the printer 1, image forming operation is carried out as follows.

First, the surface of the photosensitive drum 10 is electrically charged by the charger 11. Then, exposure corresponding to the image data is carried out to the photosensitive drum 10 by a laser light (refer to a two-dot chain line P in FIG. 1) from the exposure device 7, thereby forming an electrostatic latent image on the surface of the photosensitive drum 10. Subsequently, the development device 12 develops the electrostatic latent image to a toner image by a toner.

On the other hand, a sheet picked up from the sheet feeding cartridge 3 by the sheet feeding part 16 is conveyed to the transferring part 17 in a suitable timing for the above-mentioned image forming operation, and then, the toner image on the photosensitive drum 10 is transferred onto the sheet in the transferring part 17. The sheet with the transferred toner image is conveyed to a downstream side in the conveying path 15 to be inserted to the fixing device 18, and then, the toner image is fixed onto the sheet in the fixing device 18. The sheet with the fixed toner image is ejected from the sheet ejecting part 19 to the ejected sheet tray 4. The toner remained on the photosensitive drum 10 is collected by the cleaning device 14.

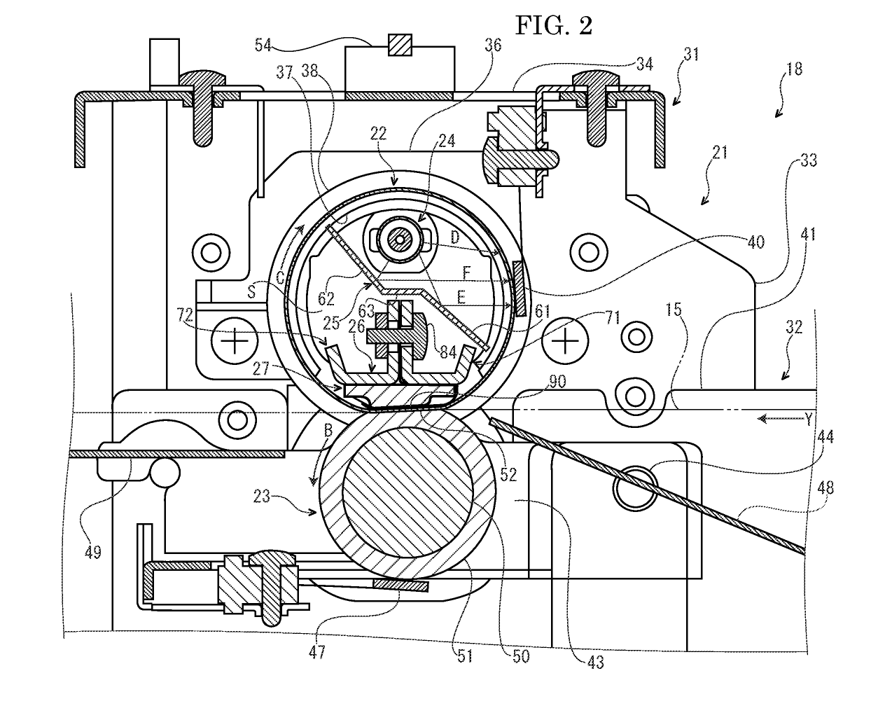

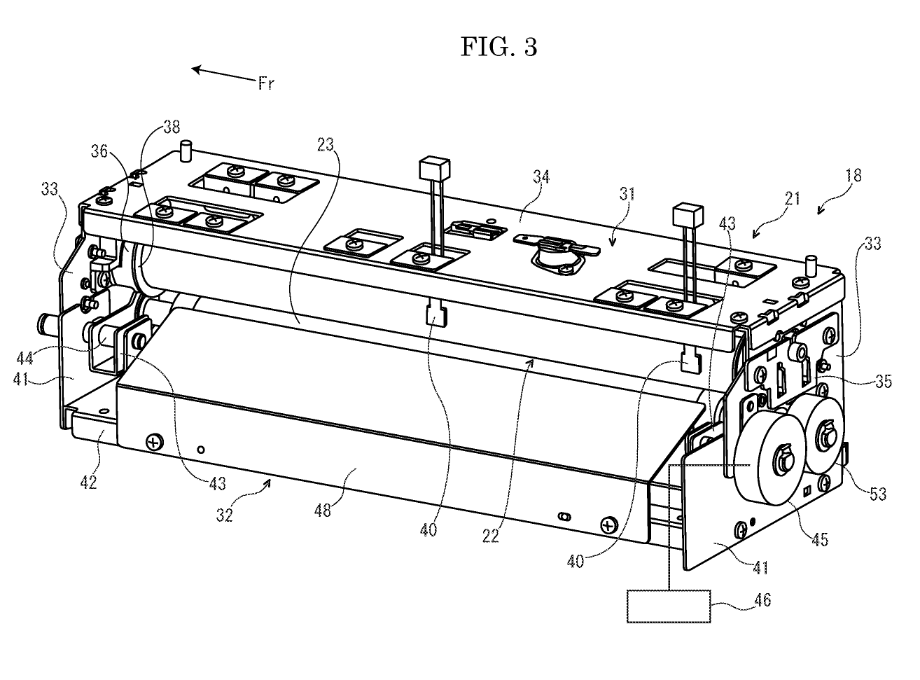

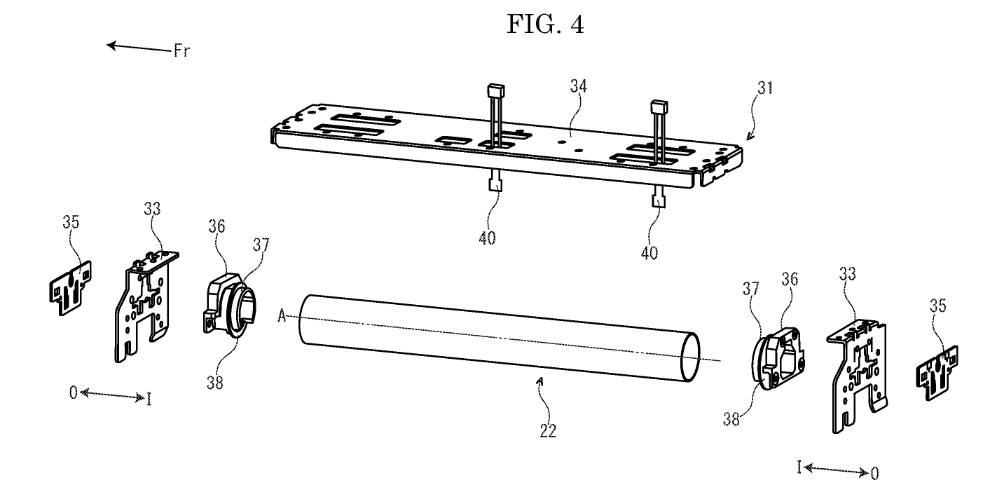

Next, the fixing device 18 will be described in detail. Hereinafter, it will be described so that the front side of the fixing device 18 is positioned at the near side of FIG. 2, for convenience of explanation. An arrow Y of FIG. 2 indicates a conveying direction of the sheet (in the present embodiment, left and right direction). Arrow Fr of FIGS. 3 and 4 indicates a front side of the fixing device 18. An arrow I of FIG. 4 indicates an inside in a front and rear direction and an arrow O of FIG. 4 indicates an outside in the front and rear direction.

As shown in FIG. 2 or the like, the fixing device 18 includes a box-like formed fixing frame 21, a fixing belt 22 housed in an upper part of the fixing frame 21, a pressuring roller 23 (a pressuring member) housed in a lower part of the fixing frame 21, a heater 24 (a heat source) arranged at an inside of the fixing belt 22 in a radial direction, a reflecting member 25 arranged at the inside of the fixing belt 22 in the radial direction and at a lower side of the heater 24, a supporting member 26 arranged at the inside of the fixing belt 22 in the radial direction and at a lower side of the reflecting member 25, a pressing member 27 arranged at the inside of the fixing belt 22 in the radial direction and at a lower side of the supporting member 26.

The fixing frame 21 is made of a plate metal. As shown in FIG. 3 or the like, the fixing frame 21 is composed of an upper frame part 31 and a lower frame part 32 connected to each other.

The upper frame part 31 of the fixing frame 21 includes a pair of front and rear upper side end plates 33 and a top plate 34 connecting upper end parts of the upper side end plates 33.

As shown in FIG. 4 or the like, to an outer face of each upper side end plate 33 of the upper frame part 31, a heater attachment plate 35 is fixed. To an inner face of each upper side end plate 33, a belt attachment base 36 is fixed. An arc-like belt supporting part 37 is arranged at an end part inside in the front and rear direction of each belt attachment base 36. Around outer circumference of the belt supporting part 37, annular meandering restriction ring 38 is arranged.

To the top plate 34 of the upper frame part 31, a pair of front and rear first thermistors 40 are fixed. As shown in FIG. 3 or the like, each first thermistor 40 comes into contact with a center part and a rear part of an outer circumference face of the fixing belt 22.

The lower frame part 32 of the fixing frame 21 includes a pair of front and rear lower side end plates 41 and a bottom plate 42 connecting lower parts of the lower side end plates 41.

To an inside in the front and rear direction of each lower side end plate 41 of the lower frame part 32, swing frames 43 are arranged. At a right end side of each swing frame 43, a spindle 44 is arranged and each swing frame 43 is configured to swing around each spindle 44 as a fulcrum. At a rear side (outside in the front and rear direction) of the rear lower side end plate 41, an input gear 45 is arranged coaxially with each spindle 44. The input gear 45 is connected to a drive source 46 composed of a motor or the like.

As shown in FIG. 2 or the like, to the lower frame part 32, a second thermistor 47 is fixed. The second thermistor 47 comes into contact with an outer circumference face of the pressuring roller 23. At the lower frame part 32, an entry guide 48 and an ejecting guide 49 is arranged.

The fixing belt 22 is formed in a roughly cylindrical shape elongated in the front and rear direction. The fixing belt 22 has flexibility and is formed in an endless shape in a circumferential direction. The fixing belt 22 has a diameter of 30 mm, for example.

The fixing belt 22 includes, for example, a base material layer, an elastic layer provided around the base material layer and a release layer covering the elastic layer. The base material layer of the fixing belt 22 is made of, for example, metal, such as steel special use stainless (SUS) with a thickness of 30 μm. Incidentally, the base material layer of the fixing belt 22 may be made of resin, such as polyimide (PI). The elastic layer of the fixing belt 22 is made of, for example, a silicone rubber with a thickness of 270 μm. The release layer of the fixing belt 22 is made of, for example, perfluoro alkoxy alkane (PFA) tube with a thickness of 30 μm. Each figure shows the respective layers (the base material layer, the elastic layer and the release layer) of the fixing belt 22 without especially distinguishing. To an inner circumference face of the fixing belt 22, a black coating is applied to improve heat absorptivity.

Into both front and rear end parts of the fixing belt 22, the belt supporting part 37 (refer to FIG. 4 or the like) arranged at each belt attachment base 36 of the upper frame part 31 is inserted. Thereby, the fixing belt 22 is rotatably supported by the upper frame part 31. The fixing belt 22 is rotatable around a rotation axis A (refer to FIG. 4 or the like) extending in the front and rear direction. That is, in the present embodiment, the front and rear direction is a rotation axis direction of the fixing belt 22. Both front and rear end faces of the fixing belt 22 are arranged at an inside in the front and rear direction of the meandering restriction ring 38 arranged in each belt attachment base 36 of the upper frame part 31. Thereby, meandering (movement to an outside in the front and rear direction) of the fixing belt 22 is restricted.

The pressuring roller 23 (refer to FIG. 2 or the like) is formed in a roughly columnar shape elongated in the front and rear direction. The pressuring roller 23 has a diameter of 25 mm, for example.

The pressuring roller 23 is composed of, for example, a columnar core material 50, an elastic layer 51 provided around the core material 50 and a release layer (not shown) covering the elastic layer 51. The core material 50 of the pressuring roller 23 is made of, for example, metal, such as iron with a diameter of 18 mm. The elastic layer 51 of the pressuring roller 23 is made of, for example, silicone rubber with a thickness of 3.5 mm. The release layer (not shown) of the pressuring roller 23 is made of, for example, PFA tube.

The pressuring roller 23 is arranged at a lower side (an outside) of the fixing belt 22. The pressuring roller 23 comes into pressure contact with the fixing belt and, between the fixing belt 22 and the pressuring roller 23, a fixing nip 52 is formed. Incidentally, the conveying direction of the sheet is, for example, a conveying direction when the sheet passes through the fixing nip 52. The pressuring roller 23 is rotatably supported by a center part in a longitudinal direction (in the present embodiment, a center part in the left and right direction) of each swing frame 43 of the fixing frame 21. Each swing frame 43 is configured to swing around each spindle 44 to move the pressuring roller 23 in the upper and lower direction so that the pressure of the fixing nip 52 is shifted.

As shown in FIG. 3, to a rear end part of the pressuring roller 23, a drive gear 53 is fixed. The drive gear 53 is meshed with the input gear 45 and connected to the drive source 46 via the input gear 45.

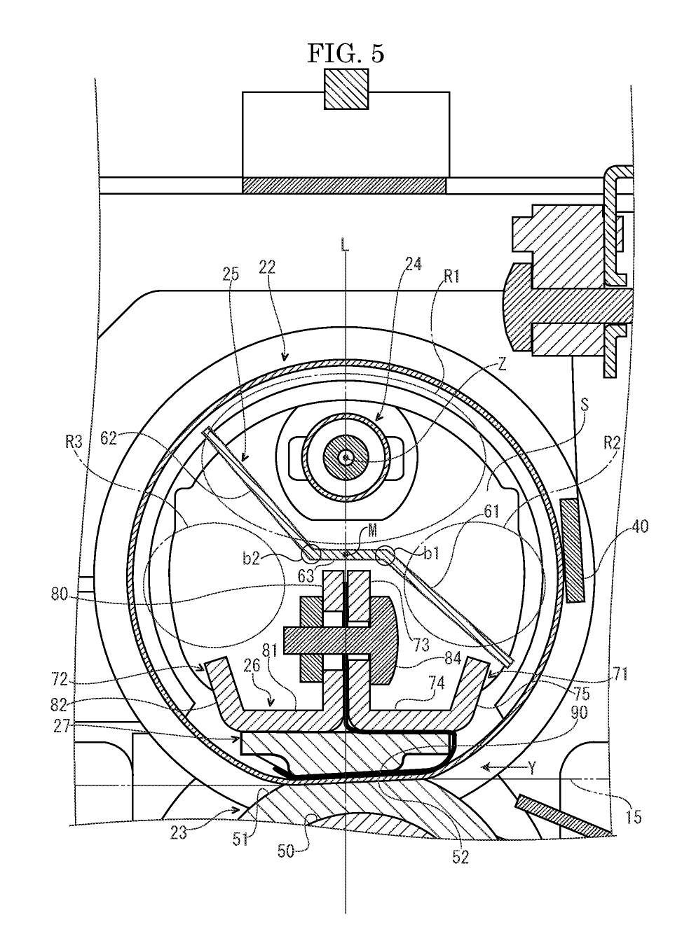

The heater 24 (refer to FIG. 5 or the like) is composed of, for example, a halogen heater. The heater 24 is arranged at an upper side area R1 (a far side area from the fixing nip 52) at an inside space S of the fixing belt 22 in the radial direction. Both front and rear end parts of the heater 24 are attached to the heater attachment plate 35 (refer to FIG. 4) of the upper frame part 31 of the fixing frame 21. The heater 24 is configured to generate heat by energizing so as to radiate a radiant heat.

The reflecting member 25 (refer to FIG. 5 or the like) is formed in a shape elongated in the front and rear direction. The reflecting member 25 is formed in an asymmetrical shape with respect to a vertical straight line L which passes through a center Z of the heater 24 and a center part M of the reflecting member 25 in the left and right direction and extends in a direction orthogonal to the left and right direction. The reflecting member 25 is made of a metal, such as an aluminum alloy for brightening. The reflecting member 25 is arranged so as to partition the heater 24 from the supporting member 26. A top face of the reflecting member 25 (a face at a side of the heater 24) is a reflecting face (mirror face) which reflects a radiant heat radiated from the heater 24, to an inner circumference face of the fixing belt 22. The reflecting member 25 is arranged to cover an upper side of the supporting member 26 (the side of the heater 24).

The reflecting member 25 includes a first reflecting part 61, a second reflecting part 62 which is provided at a more left side (a downstream side in the sheet conveying direction) and upper side (a far side from the fixing nip 52) than the first reflecting part 61 and a third reflecting part 63 which connects the first reflecting part 61 with the second reflecting part 62. A boundary part b1 between the first reflecting part 61 and the third reflecting part 63 of the reflecting member 25 and a boundary part b2 between the third reflecting part 63 and the second reflecting part 62 are bent in V shapes.

The first reflecting part 61 and the second reflecting part 62 incline to a lower side (a side of the fixing nip 52) toward a right side (an upstream side in the sheet conveying direction). The second reflecting part 62 covers a left side (the downstream side in the sheet conveying direction) of the heater 24. The third reflecting part 63 is provided along the left and right direction (sheet conveying direction).

The supporting member 26 is formed in a shape elongated in the front and rear direction. The supporting member 26 includes an upstream side stay 71 and a downstream side stay 72. The upstream side stay 71 and the downstream side stay are made of sheet metals, such as SECC (galvanized steel sheet) having the thickness of 2.0 mm, for example.

The upstream side stay 71 includes an upstream side base plate 73 which extends in upper and lower direction, an upstream side support plate which is bent from a lower end part of the upstream side base plate 73 to the right side (the upstream side in the sheet conveying direction) and an upstream side guide plate 75 which is bent from a right end part of the upstream side support plate 74 to an upper right side.

The downstream side stay 72 is arranged at a left side (the downstream side in the sheet conveying direction) of the upstream side stay 71. The downstream side stay 72 includes a downstream side base plate 80 which extends in the upper and lower direction, a downstream side support plate 81 which is bent from a lower end part of the downstream side base plate 80 to the left side (the downstream side in the sheet conveying direction) and a downstream side guide plate 82 which is bent from a left end part of the downstream side support plate 81 to an upper left side. The downstream side base plate 80 is fixed to the upstream side base plate 73 by a screw 84.

The pressing member 27 is formed in a plate-like shape elongated in the front and rear direction. The pressing member 27 is made of a metal, such as aluminum, or a heat resistant resin such as LCP (Liquid Crystal Polymer).

A top face of the pressing member 27 comes into contact with a bottom face of the supporting member 26 (more specifically, the bottom face of the upstream side support plate 74 of the upstream side stay 71 and the bottom face of the downstream side support plate 81 of the downstream side stay 82). Thus, the pressing member 27 is supported by the supporting member 26, and a warp (deformation caused by a fixing load) of the pressing member 27 is suppressed.

The bottom face of the pressing member 27 inclines to a lower side (a side of the pressuring roller 23) from the right side (the upstream side in the sheet conveying direction) toward the left side (the downstream side in the sheet conveying direction). The bottom face of the pressing member presses the fixing belt 22 to the lower side (the side of the pressing roller 23).

Between the bottom face of the pressing member 27 and the inner circumference face of the fixing belt 22, a sheet member 90 is interposed. The sheet member 90 is made of a fluorine-based resin, such as PTFE, and has a lower friction coefficient than that of the pressing member 27. In addition, between the bottom face of the pressing member 27 and the inner circumference face of the fixing belt 22, a lubricant (grease) may be applied.

To fix a toner image to a sheet in the fixing device 18 to which the above configuration is applied, the drive source 46 is driven. When the drive source 46 is driven in this way, a rotation of the drive source 46 is transmitted to the pressuring roller 23 via the input gear 45 and the drive gear 53, and the pressuring roller 23 rotates as indicated by arrow B in FIG. 2. When the pressuring roller 23 rotates in this way, as indicated by arrow C in FIG. 2, the fixing belt 22 which comes into pressure contact with the pressuring roller 23 is driven and rotated in a direction opposite to that of the pressuring roller 23. When the fixing belt 22 rotates in this way, the fixing belt 22 slides against the pressing member 27 and the sheet member 90.

Further, to fix a toner image to a sheet, the heater 24 is activated (turned on). When the heater 24 is activated in this way, the heater 24 radiates a radiant heat. As indicated by arrow D in FIG. 2, a part of the radiant heat of the heater is directly radiated on a right side part (a part before going into the fixing nip 52) of the inner circumference face of the fixing belt 22, and is absorbed. Further, as indicated by arrow E in FIG. 2, another part of the radiant heat of the heater 24 is reflected to the right side part of the inner circumference face of the fixing belt 22 by the first reflecting part 61 of the reflecting member 25 and is absorbed by the inner circumference face of the fixing belt 22. Furthermore, as indicated by arrow F in FIG. 2, still another part of the radiant heat radiated from the heater 24 is reflected to the right side part of the inner circumference face of the fixing belt 22 by the second reflecting part 62 of the reflecting member 25, and is absorbed by the right side part of the inner circumference face of the fixing belt 22. According to the above function, the heater 24 intensively heats the right side part (the part before going into the fixing nip 52) of the inner circumference face of the fixing belt 22. When a sheet passes through the fixing nip 52 in this state, a toner image is heated and then melts, and then the toner image is fixed to the sheet.

In the present embodiment, as described above, the reflecting member 25 includes the first reflecting part 61 which inclines to the lower side (the side of the fixing nip 52) toward the right side (the upstream side in the sheet conveying direction), and the second reflecting part 62 which is provided at the more left side (the downstream side in the sheet conveying direction) and upper side (the far side from the fixing nip 52) than the first reflecting part 61 and covers the left side (the downstream side in the sheet conveying direction) of the heater 24. Hence, the reflecting member 25 can intensively reflect the radiant heat from the heater 24 to the right side part (the part before going into the fixing nip 52) of the fixing belt 22. According to this, it is possible to intensively heat the right side part of the fixing belt 22, and efficiently rise the temperature of the fixing nip 52 and securely fix a toner image to the sheet.

Further, as shown in FIG. 5 or the like, in the upper side area R1 (the area at a far side from the fixing nip 52) in an inside space S of the fixing belt 22 in a radial direction, the heater 24 is arranged. By applying such a configuration, compared to a case where the heater 24 is arranged in a right side area R2 (an area at the upstream side in the sheet conveying direction) or a left side area R3 (an area at the downstream side in the sheet conveying direction) in the above-mentioned space S, it is possible to separate the supporting member 26 and the pressing member 27 arranged around the fixing nip 52 from the heater 24. According to this, it is possible to prevent temperatures of the supporting member 26 and the pressing member 27 from rising.

Further, the reflecting member 25 further includes the third reflecting part 63 which is provided along the left and right direction (sheet conveying direction) and connects the first reflecting part 61 with the second reflecting part 62. By applying such a configuration, it is possible to separate the heater 24 from the reflecting member 25 and, consequently, prevent the temperature of the reflecting member 25 from rising. According to this, it is possible to increase an operating life of the reflecting member 25.

Further, the second reflecting part 62 of the reflecting member 25 inclines to the lower side (the side of the fixing nip 52) toward the right side (the upstream side in the sheet conveying direction). By applying such a configuration, the reflecting member 25 can reflect a radiant heat from the heater 24 to a wider range of the fixing belt 22.

Further, the reflecting member 25 is arranged so as to partition the heater 24 from the supporting member 26. By applying such a configuration, it is possible to prevent the radiant heat of the heater 24 from directly radiating the supporting member 26. According to this, it is possible to reduce a heat absorbed by the supporting member 26, enhance temperature rising performance of the fixing belt 22 and enhance energy saving performance of the fixing device 18.

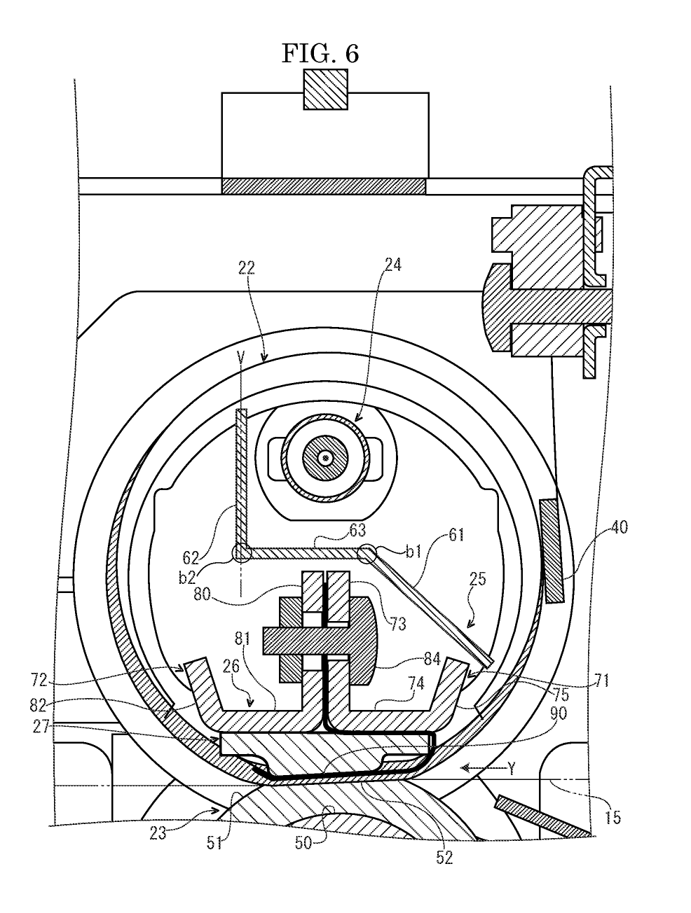

In the present embodiment, the case where the second reflecting part 62 of the reflecting member 25 inclines to the lower side (the side of the fixing nip 52) toward the right side (the upstream side in the sheet conveying direction) is explained. On the other hand, in another embodiment, as shown in FIG. 6, the second reflecting part 62 of the reflecting member 25 may be arranged along a vertical direction V (a direction orthogonal to the conveying direction of the sheet). By applying such a configuration, it becomes possible to easily separate the heater 24 from the reflecting member so as to prevent the temperature of the reflecting member 25 from rising.

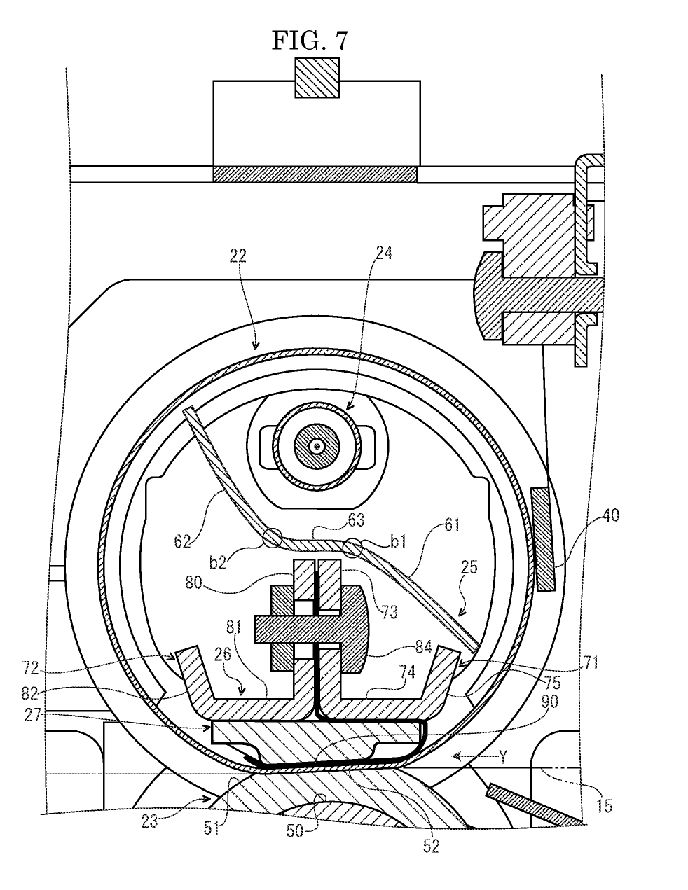

In the present embodiment, the case where the boundary part b1 between the first reflecting part 61 and the third reflecting part 63 of the reflecting member 25 and the boundary part b2 between the third reflecting part 63 and the second reflecting part 62 are bent in V shapes. On the other hand, in another embodiment, as shown in FIG. 7, the boundary part b1 between the first reflecting part and the third reflecting part 63 of the reflecting member 25 and the boundary part b2 between the third reflecting part 63 and the second reflecting part 62 may be curved in an arc shape.

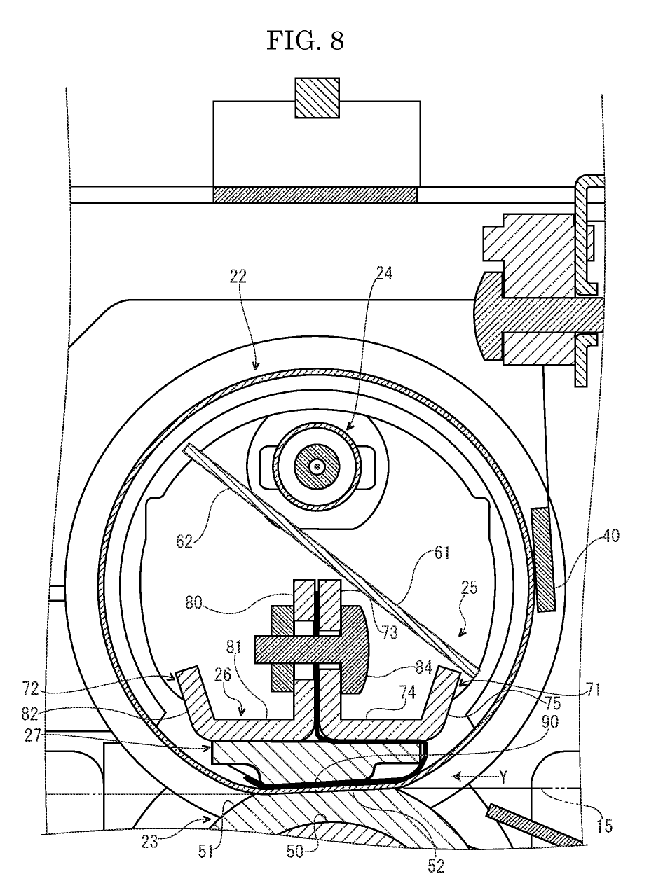

In the present embodiment, the case where the first reflecting part 61 and the second reflecting part 62 of the reflecting member 25 are connected via the third reflecting part 63 is explained. On the other hand, in another embodiment, as shown in FIG. 8, the first reflecting part 61 and the second reflecting part 62 of the reflecting member 25 may be connected directly. By applying such a configuration, it becomes possible to make the shape of the reflecting member 25 simple.

In the present embodiment, a case where a single heater 24 is arranged at the inside of the fixing belt 22 in the radial direction is explained. On the other hand, in another embodiment, a plurality of heaters may be arranged at the inside of the fixing belt 22 in the radial direction. In such a case, a plurality of the heaters are preferably arranged at the upper side area R1 (the far side area from the fixing nip 52) at the inside space S of the fixing belt 22 in the radial direction to prevent the temperature of the supporting member 26 and the pressing member 27 from rising.

In the present embodiment, a case where the halogen heater is used as a heater 24 is explained. On the other hand, in another embodiment, a ceramic heater or the like may be used as the heater 24.

In the present embodiment, a case where the configuration of the present invention is applied to the printer 1 is explained. On the other hand, in another embodiment, the configuration of the invention may be applied to another image forming apparatus, such as a copying machine, a facsimile or a multifunction peripheral.

1. A fixing device comprising:
a fixing belt configured to be rotatable;
a pressuring member configured to be rotatable and to come into pressure contact with the fixing belt so as to form a fixing nip;
a heat source arranged at an inside in a radial direction of the fixing belt and configured to radiate a radiant heat; and
a reflecting member configured to reflect the radiant heat radiated from the heat source to an inner circumference face of the fixing belt,
wherein the reflecting member includes:
a first reflecting part configured to incline to a side of the fixing nip toward an upstream side in a conveying direction of a recording medium; and
a second reflecting part arranged at a more downstream side than the first reflecting part in the conveying direction of the recording medium and at a further side from the fixing nip than the first reflecting part and configured to cover a downstream side of the heat source in the conveying direction of the recording medium.

2. The fixing device according to claim 1,
wherein the heat source is arranged at a far side area from the fixing nip at an inside space of the fixing belt in the radial direction.

3. The fixing device according to claim 1,
wherein the reflecting member further includes a third reflecting part arranged along the conveying direction of the recording medium and configured to connect the first reflecting part with the second reflecting part.

4. The fixing device according to claim 3,
wherein a boundary part between the first reflecting part and the third reflecting part and a boundary part between the third reflecting part and the second reflecting part are bent in a V shape.

5. The fixing device according to claim 3,
wherein a boundary part between the first reflecting part and the third reflecting part and a boundary part between the third reflecting part and the second reflecting part are curved in an arc shape.

6. The fixing device according to claim 1,
wherein the first reflecting part and the second reflecting part are connected directly.

7. The fixing device according to claim 1,
wherein the second reflecting part is configured to incline to the side of the fixing nip toward the upstream side in the conveying direction of the recording medium.

8. The fixing device according to claim 1,
wherein the second reflecting part is arranged along a direction orthogonal to the conveying direction of the recording medium.

9. The fixing device according to claim 1, further comprising:
a pressing member configured to press the fixing belt to a side of the pressuring member; and
a supporting member configured to support the pressing member,
wherein the reflecting member is arranged so as to partition the heat source from the supporting member.

10. The fixing device according to claim 9,
wherein the supporting member includes:
an upstream side stay; and
a downstream side stay arranged at a downstream side of the upstream side stay in the conveying direction of the recording medium.

11. The fixing device according to claim 1,
wherein the reflecting member is asymmetrical with respect to a straight line which passes through a center part of the reflecting member in the conveying direction of the recording medium and extends in a direction orthogonal to the conveying direction of the recording medium.

12. An image forming apparatus comprising the fixing device according to claim 1.
